(19) United States
(12) Patent Application Publication
(10) Pub. No.: US 2010/0140972 A1
(43) Pub. Date: Jun. 10, 2010

(54) Tool top

(76) Inventor: Patrick Lynn Daylong, (US)

Correspondence Address: Patrick Daylong, 1520 Blackjack, Lockhart, TX, 78644, US

(21) Appl. No.: 12/590,833

(22) Filed: Nov. 16, 2009

Related U.S. Application Data
(60) Provisional application No. 61/199,330, filed on Nov. 17, 2008.

(51) Int. Cl. B60P 7/02

(52) U.S. Cl. 296/100.06

(57) ABSTRACT

The “Tool Top” design is an innovative way to combine a pickup bed shell with a traditionally mounted tool box across the pickup bed.

The first step in building a “Tool Top” is to get precise measurements of the pickup bed and the back of the cab. These measurements can be done manually or with computer aided measuring devises that use lasers or five axes touch machines.

If hand laid fiberglass is used to build the “Tool Top” shell; a measured plug (made of wood, foam, fiberglass, or other materials) in the shape desired will have to be built. Then a fiberglass mold will be built over the plug in a way to assure that the mold can be separated from the plug. Once the mold is removed the pieces will be bolted back together and stabilized. Then the mold will be prepared and refined before the final fiberglass part is laid up.

The shell can be designed with a CAD program and stamped from steel in three pieces, injection molded from plastic or press molded from fiberglass with a two piece mold.

The locking gull-winded doors can be made of bent glass or polyurethane that can be acquired from a number of sources. The rear hatch door can also be made of glass or polyurethane supported by a frame of aluminum or fiberglass. All windows will be tinted to prevent sun damage to items carried in the bed. A locking mechanism secures the hatch door which comes down over the tail gate to prevent opening for added protection.

Hardware such as hinges, latches, weather strips, gaskets and lift struts are readily available and can be ordered to the builder's specifications.

The tool box can be built from steel or it can be molded from plastic or fiberglass. The sliding covers and inside drawers or racks will be made from the same elements.

Specifications for application Ser. No. 12/590,833 Date November 16, 2009

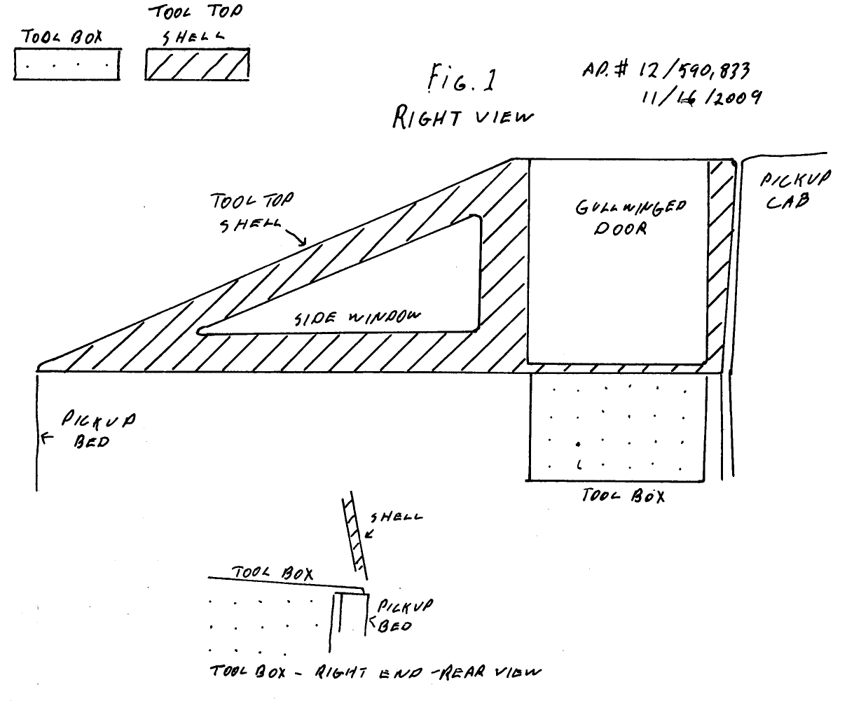

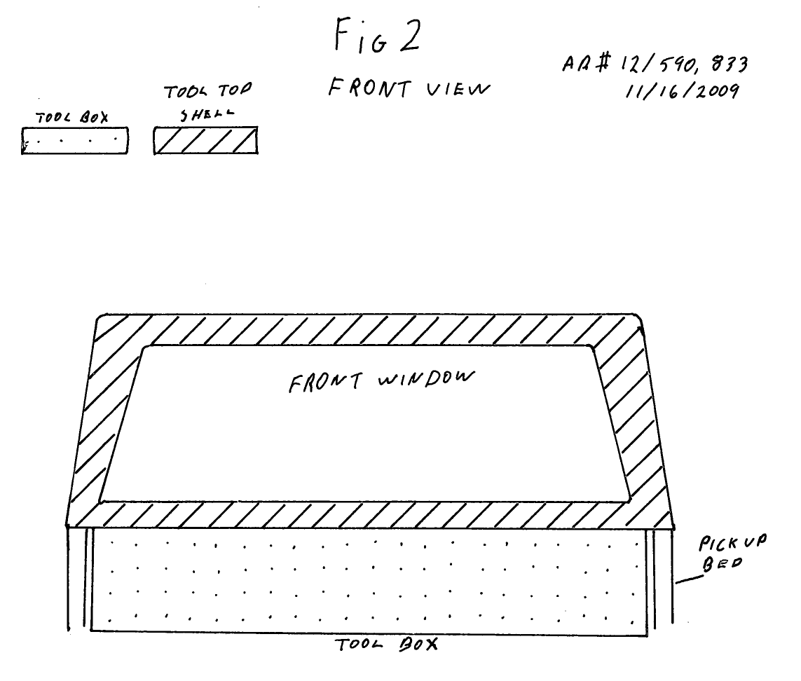

The “Tool Top” is a pickup bed shell that incorporates a tool box across the pickup bed directly behind the cab of the pickup. Gull-winged doors on each side of the shell provide access to the tool box directly behind the pickup cab. Aft of the gull-winged doors, the shell slopes back in a fastback design to the top of the tail gate. The glass or polyurethane will be tinted to protect the bed contents from sun damage and make it harder for someone to see what is in the bed. The gull-winged doors and hatch back have locking mechanisms for added security. (see FIGS. 1 & 3)

In the fastback area there is a hatch door made of glass or polyurethane that is as wide as the bed opening at the rear and as wide as is possible at the top near the gull-winged doors. The hatch door closes against the top of the tail gate to keep the tail gate from being opened when the hatch is locked. The hatch door opens wide for easy access to the bed, left opened to accommodate long items such as lumber or ladders, or completely removed so that the user can easily haul a tall load without removing the entire shell. The design helps protects items in the bed from the weather, dirt and theft.

Because each pickup model has a different bed size and shape, the dimensions of the “Tool Top” will vary. The critical aspect of the “Tool Top” is the incorporation of the toolbox, the gull-winged doors and the removable fastback hatch door which increases gas mileage and provides security for the toolbox and bed contents. To produce a “Tool Top” for a specific pickup, the bed and the back of the cab can be digitally scanned or manually measured to make the clearance between the cab and the front of the “Tool Top” as small as is practical. The outer edges of the shell that mate with the pickup bed should be flush with the outer edge of the bed so as to make the fit as smooth as possible for increased aerodynamics and overall appearance.

The material used to manufacture the “Tool Top” can be any number of materials that can be molded stamped or injected into a mold. Fiberglass, steel or plastic is the most likely material that will be used.

The tool box can be made of steel, plastic or fiberglass and may have a variety of lids and drawers. The most practical lid design is a sliding lid design that allows the top lid slide over the bottom and the bottom lid slide under the top lid.

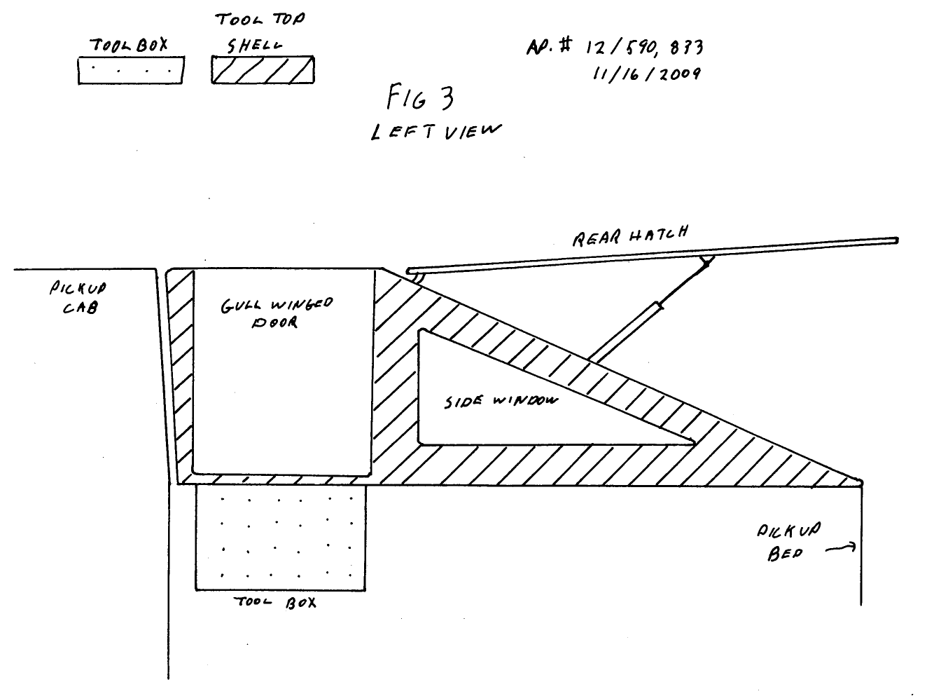

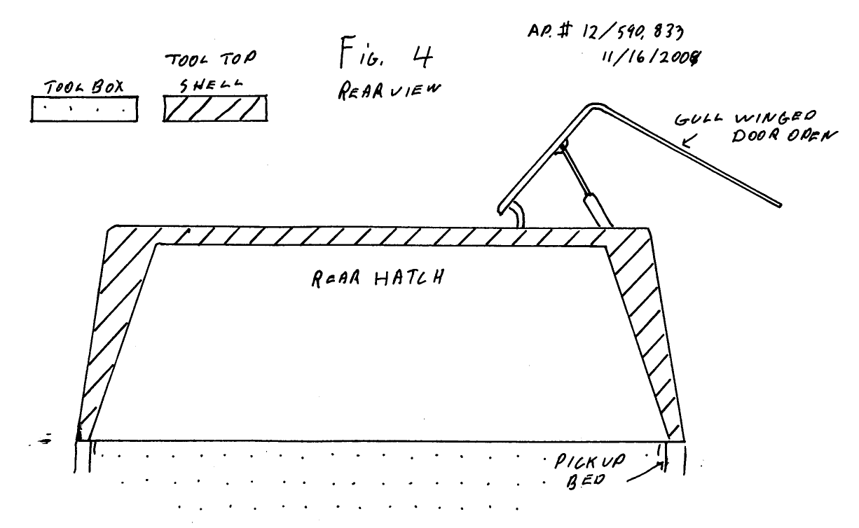

The “Tool Top” has a front window that allows the pickup operator to see through the “Tool Top” and out the rear hatch door which is made of glass or polyurethane, with an aluminum or fiberglass frame. (see FIG. 2)

The lower edges of the “Tool Top” are fitted flush with the outside edge of the pickup bed, with a rubber gasket in between, for a tight fit and to maximize aerodynamics for better fuel economy. (see FIG. 2)

The gull-winged doors, rear hatch door and side windows should be as flush as is practical with the outside of the shell to increase aerodynamics. All can be locked to protect the contents. (see FIG. 2)

1. The “Tool Top” pickup bed shell is unique because it comprises an improvement over other pickup bed shells by incorporating a tool box across the pickup bed inside the shell, it utilizes locking gull-wing doors to access the tool box, a fast back design and a locking hatch back door that secures the tail gate and can be easily removed. The shell is designed with locking gull-winged doors on both sides to give easy access to the tool box and secure the tool box inside the shell. The “Tool Top” is further unique because the fastback rear hatch door affords a wide opening for easy loading and the hatch door is removable so that the pickup bed can be used to haul tall items without removing the entire shell from the pickup bed. There are similar shapes for pickup bed shells but none that incorporate an across the bed tool box with gull-winged doors or an easily removable hatch back door as the “Tool Top” does.
